(19) United States
(12) Patent Application Publication
(10) Pub. No.: US 2016/0026306 A1
(43) Pub. Date: Jan. 28, 2016

(54) HAND-HELD ELECTRONIC DEVICE, TOUCH-SENSING COVER AND COMPUTER-EXECUTED METHOD

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/722,856

(22) Filed: May 27, 2015

(30) Foreign Application Priority Data
Jul. 25, 2014 (CN) 201410361462.6

(51) Int. Cl. G06F 3/047; G09G 5/18; G09G 5/00

(52) U.S. Cl. CPC G06F 3/047; G09G 5/003; G09G 5/18; G09G 2300/04

(57) ABSTRACT

In a shadeless touch hand-held electronic device, partial or whole area of the touch-sensing structure is disposed on the cover, the panel displays an image capture interface. The control unit is electrically connected to the touch-sensing cover, the panel and the image capture unit, and executes following steps of: computing the a trigger event of a plurality of detection points of the touch-sensing structure; comparing the trigger event with an initiative determination condition pre-stored in the shadeless touch hand-held electronic device; permitting the touch-sensing structure to receive at least one input action inputted by a user if the trigger event conforms to the initiative determination condition; and executing an operation corresponding to the input action. The operation includes that the image capture unit performs a functional action or the image capture interface performs a mode transform.

### CROSS REFERENCE TO RELATED APPLICATIONS

This Non-provisional application claims priority under 35 U.S.C. §119(a) on Patent Application No(s). 201410361462.6 filed in People's Republic of China on Jul. 25, 2014, the entire contents of which are hereby incorporated by reference.

### BACKGROUND

1. Technical Field

The invention relates to a hand-held electronic device, in particular to a shadeless touch hand-held electronic device, a touch-sensing cover and a computer-executed method wherein an input action inputs on the touch-sensing cover by a user to make the image capture unit perform a functional action, or to make the image capture interface perform a mode transform.

2. Related Art

With the progress of technologies, various novel information devices capable of telecommunication are invented, such as cell phones, tablet computers, ultrabooks, GPS (Global Positioning System) navigation device, or other portable communication devices. In addition to conventional input or control manners by keyboard or mouse, utilizing the touch control technique to operate the information device is a straight and popular operative manner. The touch display device has a friendly and straight input operative interface, and therefore users of all ages can operate the touch display device by fingers.

As to the common and conventional hand-held electronic device with the touch function, the touch operations are all directly executed on the display panel. However, for the operation on the panel, fingers will shade the user's view or the software item displayed by the display panel, such that the user may erroneously touch and open an undesired link arranged in a high information content density on the display panel by user's finger. To avoid the above situation, some electronic devices adopt a design where the touch operation zone is separated from the display panel, such as disclosed by the U.S. Pat. No. 5,825,352 (Logitech).

However, such design will increase the volume of the electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve the problem of that user's view is easily shaded by user's finger in the operation of the hand-held electronic device caused by the finger.

Furthermore, the above-mentioned panel also needs to be configured with the rare earth transparent touch-sensing structure such as ITO (indium tin oxide) so as to be kept in touch control and display capability. However, since the rare earth metal indium is unceasingly consumed, the cost of the product is getting higher and higher. Besides, the conductivity of the rare earth metal is worse than the normal metal. Therefore, it is not a good choice to use the rare earth to make the transparent touch-sensing layer. In addition, when the user uses the hand-held electronic device under strong sunlight, the sunlight readability of the panel is always a problem which can not be effectively solved. So, it's really a disturbance to operation because they can not see the information from the panel during the above-mentioned state.

In addition, because user's finger or stylus needs to contact the touch panel for controlling or operating the electronic device, it often scratches the panel. Besides, when operating well-known hand-held electronic device with touch control function, it usually requires one hand to hold the hand-held electronic device and the other hand to execute operation on the panel. If using just one hand to hold and operate the device, only the user's thumb can manipulate the device and thus reduce efficiency, accuracy and convenience of manual operation.

Therefore, it is important to provide a shadeless touch hand-held electronic device, a touch-sensing cover and a computer-executed method which can prevent the user's view from being shaded by fingers, reduce the scratch problem, and is suitable to be operated by one hand.

### SUMMARY

An aspect of the invention is to provide a shadeless touch hand-held electronic device, a touch-sensing cover and a computer-executed method which can prevent the user's view from being shaded by fingers, reduce the scratch problem and is suitable to be operated by one hand are provided.

A shadeless touch hand-held electronic device includes a touch-sensing cover, a panel, an image capture unit and a control unit. The touch-sensing cover has a cover and a touch-sensing structure, partial or whole area of the touch-sensing structure is disposed on the cover, and the touch-sensing structure has a plurality of detection points. The panel displays an image capture interface. The control unit is electrically connected to the touch-sensing cover, the panel and the image capture unit, and executes following steps of: computing the a trigger event of the detection points; comparing the trigger event with an initiative determination condition pre-stored in the shadeless touch hand-held electronic device; permitting the touch-sensing structure to receive at least one input action inputted by a user if the trigger event conforms to the initiative determination condition; and executing an operation corresponding to the input action. The operation includes that the image capture unit performs a functional action or the image capture interface performs a mode transform.

In one embodiment, the image capture unit is disposed on the shadeless touch hand-held electronic device and whereon the same side or the opposite side of the panel.

In one embodiment, the touch-sensing structure is single-layer or double-layer.

In one embodiment, a wiring connecting to the touch-sensing structure is gathered to a single side for wiring outlet.

In one embodiment, the width of the touch-sensing structure is less than that of the cover by 5%˜10%.

In one embodiment, the area of the touch-sensing structure has a ratio relationship to the area of the panel, and the control unit converts an input position of the touch-sensing structure to a display position of the panel according to the ratio relationship.

In one embodiment, the touch-sensing structure is capable of a wireless power transmission.

In one embodiment, the touch-sensing cover further includes a near field communication unit, the near field communication unit has a near field communication chip and an antenna, and the near field communication chip is electrically connected to the control unit, and the antenna is disposed on the cover or the touch-sensing structure.

In one embodiment, the user operates by one hand and the touch-sensing cover faces a light source or the back of the panel faces the light source.

In one embodiment, the material of the touch-sensing structure comprises metal mesh, metal nanowires, transparent conducting film, carbon nanotube or graphene.

In one embodiment, a computer-executed method is applied to a shadeless touch hand-held electronic device. The shadeless touch hand-held electronic device includes a touch-sensing cover, a panel, an image capture unit and a control unit, and the panel displays an image capture interface. The method executed on the shadeless touch hand-held electronic device includes following steps of: computing a trigger event of a plurality of detection points of the touch-sensing cover; comparing the trigger event with an initiative determination condition pre-stored in the shadeless touch hand-held electronic device; permitting the touch-sensing cover to receive at least one input action inputted by a user if the trigger event conforms to the initiative determination condition; and executing an operation corresponding to the input action. The operation includes that the image capture unit performs a functional action or the image capture interface performs a mode transform.

In one embodiment, the image capture unit is disposed on the shadeless touch hand-held electronic device and whereon the same side or the opposite side of the panel.

In one embodiment, if the input action is that a single finger contacts or touches or clicks the touch-sensing cover, the operation is that the image capture unit performs the functional action to photograph.

In one embodiment, if the input action is that the single finger contacts the touch-sensing cover over a default period of time, the operation is that the image capture unit performs the functional action to record a video.

In one embodiment, if the input action is that a single finger slides along a first direction on the touch-sensing cover, the operation is that the image capture interface performs the mode transform of entering a photo browsing mode from a capture mode.

In one embodiment, if the input action is that a single finger slides along a second direction on the touch-sensing cover, the operation is that the image capture interface performs the mode transform of entering a capture mode from a photo browsing mode.

In one embodiment, if the input action is that two fingers slide toward each other on the touch-sensing cover, the operation is that the image capture unit performs the functional action to zoom out.

In one embodiment, if the input action is that two fingers slide away from each other on the touch-sensing cover, the operation is that the image capture unit performs the functional action to zoom in.

In one embodiment, the trigger event includes a trigger quantity, a trigger quantity distribution, a trigger morphology (which can refer to trigger appearance), a trigger time, a trigger location (which can refer to trigger position) or a trigger frequency.

A touch-sensing cover for a shadeless touch hand-held electronic device is provided. The shadeless touch hand-held electronic device comprises a touch-sensing cover, a panel, an image capture unit and a control unit, and the panel displays an image capture interface. The touch-sensing cover includes a cover and a touch-sensing structure. The cover is disposed on the side of the shadeless touch hand-held electronic device opposite the panel. Partial or whole area of the touch-sensing structure is disposed on the cover, and the touch-sensing structure has a plurality of detection points. The control unit computes a trigger event of the detection points and compares the trigger event with an initiative determination condition pre-stored in the shadeless touch hand-held electronic device. It permits the touch-sensing structure to receive at least one input action inputted by a user if the trigger event conforms to the initiative determination condition, and executes an operation corresponding to the input action, and the operation includes that the image capture unit performs a functional action or the image capture interface performs a mode transform.

As mentioned above, as to the shadeless touch hand-held electronic device, the touch-sensing cover and the computer-executed method, because the user can perform touch operation on the touch-sensing cover of the shadeless touch hand-held electronic device, his fingers will not shade the view or the software item displayed by the panel. Thus, it also avoids inadvertently touch problems of opening the link due to high information content density on the display. In addition, because the user utilizes the touch-sensing cover to operate the electronic device, the scratch on the panel can be reduced. Besides, because the user utilizes the touch-sensing cover to perform touch operation, he can hold it just by one hand and uses his finger such as forefinger or middle finger of the same hand to manipulate the electronic device. In comparison with that conventionally one hand holds it and only the thumbs can perform operation, the efficiency and convenience of hand control operation is enhanced and better user experience is achieved.

Furthermore, when using the shadeless touch hand-held electronic device under the sun or the light source, the user can hold the shadeless touch hand-held electronic device just by one hand and use the touch-sensing cover to block the sunlight or light source. Due to the panel information benefiting from the touch-sensing cover which blocks the sunlight, the sunlight visibility of the panel is improved, and it can be implemented without advanced OLED (Organic Light-Emitting Diode) or electric paper display panel technique.

Additionally, because the shadeless touch hand-held electronic device must firstly satisfy the precondition that the trigger event such as the trigger quantity, the trigger quantity distribution, the trigger morphology, the trigger time, the trigger location or the trigger frequency, etc. conforms to the initiative determination condition, then the touch-sensing cover is permitted to receive at least one input action inputted by the user and an operation is correspondingly performed according to the input action. The operation includes that the image capture unit performs a functional action or the image capture interface performs a mode transform. Therefore, when other user operates the shadeless touch hand-held electronic device, because the trigger event such as the trigger quantity, the trigger quantity distribution, the trigger morphology, the trigger time, the trigger location or the trigger frequency, etc. is distinct from the initiative determination condition which is predefined by the origin user, the shadeless touch hand-held electronic device is forbidden to operate so as to enhance the security of protecting the user information in the shadeless touch hand-held electronic device.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing the shadeless touch hand-held electronic device according to the embodiment of the invention;

FIG. 2 is a schematic block diagram showing the shadeless touch hand-held electronic device in FIG. 1;

FIG. 3 is a schematic diagram at another view angle showing the shadeless touch hand-held electronic device in FIG. 1;

FIG. 4 is a flow chart showing the steps of the computer-executed method according to the embodiment of the invention;

FIG. 5 is a schematic diagram showing that the detection points of the touch-sensing cover in FIG. 1 are triggered;

FIG. 6A to FIG. 6B are another schematic diagrams showing that the detection points of the touch-sensing cover in FIG. 1 are triggered;

FIG. 7 is a schematic diagram showing that the panel in FIG. 1 displays the image capture interface;

FIG. 8A is a schematic diagram showing that the user operates the shadeless touch hand-held electronic device in FIG. 1 along the first direction;

FIG. 8B is a schematic diagram showing that the panel in FIG. 1 displays the photo browsing mode;

FIG. 8C is a schematic diagram showing that the user operates the shadeless touch hand-held electronic device in FIG. 1 along the second direction;

FIG. 9 is a schematic diagram showing the shadeless touch hand-held electronic device in FIG. 1 in self-timer mode;

FIG. 10A is a schematic diagram showing that the user operates the shadeless touch hand-held electronic device in FIG. 1 by pinch; and

FIG. 10B is a schematic diagram showing that the user operates the shadeless touch hand-held electronic device in FIG. 1 by stretch.

### DETAILED DESCRIPTION OF THE INVENTION

The embodiments of the invention will be apparent from the following detailed description, which proceeds with reference to the accompanying drawings, wherein the same references relate to the same elements.

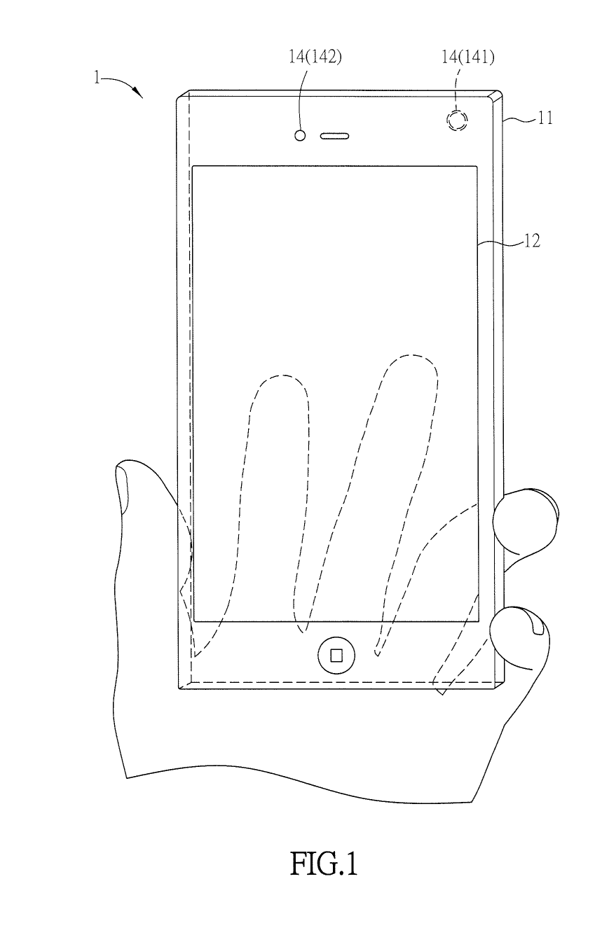

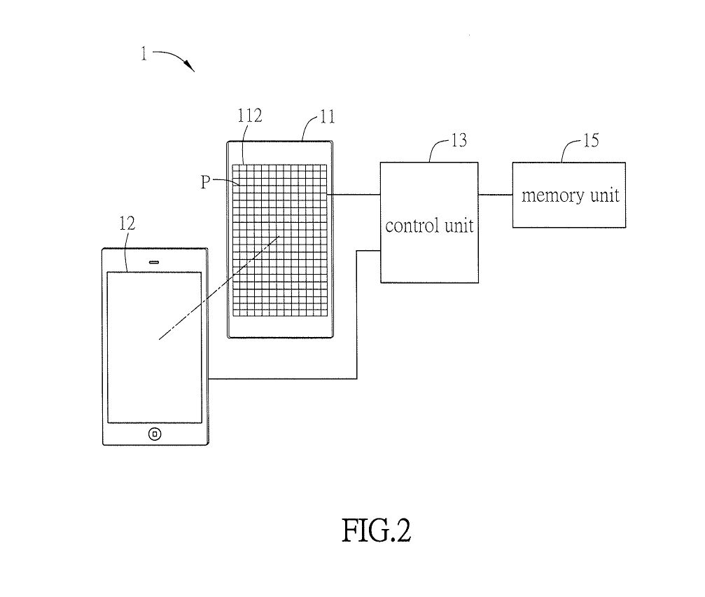

FIG. 1 is a schematic diagram showing the shadeless touch hand-held electronic device according to the embodiment of the invention. FIG. 2 is a block schematic diagram showing the shadeless touch hand-held electronic device in FIG. 1. Referring to FIG. 1 and FIG. 2, in the embodiment, the shadeless touch hand-held electronic device 1 (hereinafter the hand-held electronic device 1) comprises a touch-sensing cover 11, a panel 12, a control unit 13 and at least one image capture unit 14. The panel 12 comprises a display panel, namely, a panel with display function or alternatively a touch display panel with both display function and touch function. In this embodiment, the hand-held electronic device 1 can be a smart phone, a tablet computer, a PDA (personal digital assistant), or a GPS (global positioning system), etc. In the embodiment, it is a smart phone for example.

In the embodiment, the touch-sensing cover 11 is disposed on the side of the hand-held electronic device 1 opposite the panel 12. In other words, the touch-sensing cover 11 and the panel 12 are respectively disposed on the two opposite sides of the hand-held electronic device 1, for example, respectively disposed on the back side and the front side of the hand-held electronic device 1. In the embodiment for example, the panel 12 is disposed on the front side of the hand-held electronic device 1, and the touch-sensing cover 11 is disposed on the back side. When the user normally uses the hand-held electronic device 1, the surface facing the user is the front side and the surface against the user is the back side. The touch-sensing cover 11 and the panel 12 are respectively coupled to the control unit 13, so that the control unit 13 can control the content displayed by the panel 12 and control the designate locations of the touch-sensing cover 11 can be selected to input.

In the embodiment, the touch-sensing cover 11 provides an input interface for human-machine interaction. The panel 12 can display for example a user interface such as a GUI (Graphical User Interface). Therefore, as shown in FIG. 1, the user can see the content displayed by the panel 12 at the front side of the hand-held electronic device 1, and performs input on the touch-sensing cover 11 at the back side.

In the embodiment, the hand-held electronic device 1 further comprises an image capture unit 141 and an image capture unit 142. The image capture unit 141 is disposed on the side of the hand-held electronic device 1 opposite the panel 12. The image capture unit 141 can be called the back camera. The image capture unit 142 is disposed on the hand-held electronic device 1. The image capture unit and the panel 12 are with together on the same side of the hand-held electronic device 1. The image capture unit 142 can be called the front camera. Besides in the embodiment, the panel 12 can display an image capture interface. The image capture interface can correspondingly display the shooting range and the shooting content of the image capture unit 141 or the image capture unit 142. The contents related to the image capture interface will be explained later.

When the user utilizes the hand-held electronic device 1 under the sunlight or the light source, he can operate the hand-held electronic device 1 by one hand and take the touch-sensing cover 11 to face the light source so as to block the sunlight or the light source. Because the position of the panel 12 is against the light source its displaying information benefits from the touch-sensing cover 11 blocking the sunlight or the light source, and the sunlight visibility of the panel 12 is improved. The user can operate or input on the touch-sensing cover for the information on the panel, and the security of operating the hand-held electronic device and the convenience of operation by single hand under the sunlight are enhanced.

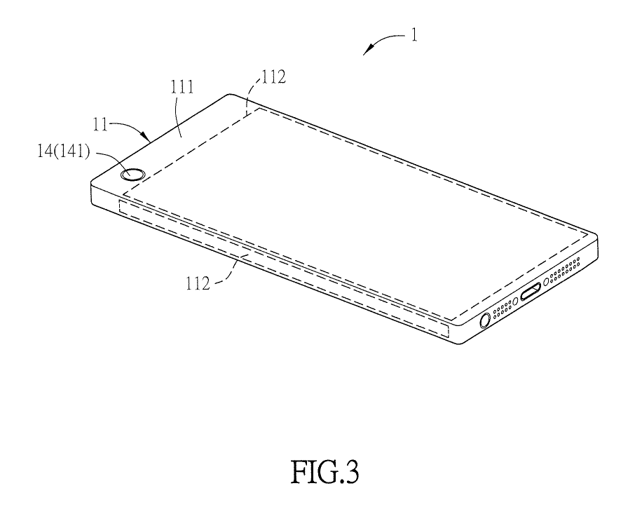

FIG. 3 is a schematic diagram at another view angle showing the shadeless touch hand-held electronic device in FIG. 1. Referring to FIG. 1 to FIG. 3, in the embodiment, the touch-sensing cover 11 comprises a cover 111 and a touch-sensing structure 112. Similarly, the cover 111 is disposed on the side of the hand-held electronic device 1 opposite the panel 12 (the surface opposite the display surface). Partial or whole area of touch-sensing structure 112 can be disposed on the cover 111. In the embodiment, the touch-sensing structure 112 extends to the two sides of the cover 111, for example extends to the two side edges of the touch-sensing cover 11, so as to increase the operation area for the user. Here, the area of the touch-sensing structure 112 is larger than the area of the panel 12. In other embodiments, the physical button can be replaced with the touch-sensing structure 112 in the embodiment, and it is not limited thereto.

In other embodiments, in order to effectively utilize the width of the cover 111 to dispose the touch-sensing structure 112, the width of the touch-sensing structure 112 is less than that of the cover 111 (for example by 5% to 10%). Namely, the width of the touch-sensing structure 112 is about 90% to 95% of the width of the cover 111. The touch-sensing structure 112 may also yield to the position of the camera lens or the flash of the cover 111, so the touch-sensing structure 112 is not disposed at a local region of the cover 111 (namely the location where the camera lens or the flash are disposed).

In other embodiments, the area of the touch-sensing structure 112 may be equal to the area of the panel 12.

The touch-sensing structure 112 can be disposed on the inner surface of the cover 111 facing the panel 12 (inside the hand-held electronic device 1), or disposed on the outer surface of the cover 111 away from the pane 112 (outside the hand-held electronic device 1), or simultaneously disposed on the inner surface of the cover 111 facing the panel 12 and the outer surface of the cover 111 away from the panel 12 (inside and outside the hand-held electronic device 1). The touch-sensing structure 112 in the embodiment can be for example capacitive, it forms on the inner surface of the cover 111 facing the panel 12, and whole area of it is directly formed on the cover 111 for example. In various embodiments, when the touch-sensing structure 112 is disposed on the outer surface of the cover 111 away from the pane 112, an additional protection layer is required to protect the touch-sensing structure 112. In addition, it is noted that the material of the cover 111 can be glass, plastic, metal or other material, and it can be a part of the whole structure of the hand-held electronic device 1. In other words, the touch-sensing cover 11 is not an additional component (such as the protection case or protection sheath of the electronic device). Therefore, if the touch-sensing cover 11 is separated from the hand-held electronic device 1, the inside parts of the hand-held electronic device 1 for example battery or IC (integrated circuit), etc. cane be seen.

Besides, the touch-sensing structure 112 can be single-layer or double-layer. The touch-sensing structure 112 is capable of a wireless power transmission.

In the embodiment, the touch-sensing structure 112 is double-layer for example. The touch-sensing structure 112 can include a first sensing layer and a second sensing layer. The first sensing layer comprises a plurality of first sensing lines which are disposed along the first direction (direction X). The second sensing layer comprises a plurality of second sensing lines which are disposed along the second direction (direction).

In other embodiment of the invention, the touch-sensing structure may be a single-layer electrode structure. For example, the touch-sensing structure may comprise a plurality of sensing pads that are formed simultaneously, and the sensing pads may be single-layer. The sensing pads may be a transparent conductive layer or a metal mesh. The shape of the sensing pad includes, but not limited to, a diamond shape or triangle, as long as they can help to achieve touch-sensing operations. Moreover, all sensing pads are not needed to have an identical shape.

In addition, the touch-sensing structure 112 can also further includes a driving circuit and a sensing circuit (i.e. the so-called Tx and Rx by the skilled person in the art, not shown in the figure), and its material can be a conductive layer (transparent conductive layer also can be used, for example ITO (indium tin oxide), IZO (indium zinc oxide), FTO (fluorine-doped tin oxide), Al-doped ZnO, Ga-doped ZnO), metal mesh, metal nanowires, transparent conducting film, carbon nanotube or graphene, and it is not limited thereto. In some embodiments, if the touch-sensing structure 112 is a metal mesh, it can alleviate Moire phenomenon and reduce material cost, and its linewidth is not restricted to transparency demand.

If the touch-sensing structure 112 is made by metal mesh, the metal texture effect can be exhibited on the appearance when the touch-sensing structure 112 is disposed on the outer surface (not the display surface) of the cover 111. Accordingly for example, the cover of metal texture is implemented by disposing the touch-sensing structure 112 composed of the metal mesh on the outer surface (not the display surface) of the cover 111 made by non-metal material. Thus, the metal-made cover (requiring a more complicated process) is unnecessary to be used, so as to further achieve the effect of saving the cost.

In addition in the embodiment, the area of the touch-sensing structure 112 has a ratio relationship to the area of the panel 12. The control unit 13 converts a touch position of the touch-sensing cover 11 to a corresponding position of the panel 12 according to the ratio relationship. When the user uses his finger on the touch-sensing cover 11 to perform touch operation, the panel 12 may display the corresponding operation instruction according to the posture (or called gesture) of the user operation. The control unit 13 converts an input position of the touch-sensing structure 112 to a display position of the panel 12. The panel 12 will display a visible sign and interact with the GUI displayed on the panel 12.

Besides, a circuit board, a battery or a memory card may be further included between the touch-sensing cover 11 and the panel 12.

Besides, the a wiring connecting to the touch-sensing structure 112 is gathered to a single side for wiring outlet, and then electrically connected with a circuit board, so as to enhance the flexibility of the circuit design.

In addition, referring to FIG. 2, the touch-sensing structure 112 has a plurality of detection points P. The detection points P can be triggered to trigger the trigger event. For example, when a conductor for example but not limited to the stylus or user's finger contacts the touch-sensing structure 112, the detection point P at the contact position is triggered to generate a signal of the trigger event and sends the signal to the control unit 13 which can determine or analyze the trigger event.

Therefore, the trigger event can be generated corresponding to the holding position by the user when he holds the touch-sensing cover 11 by hand, or it is generated when the user perform the input action on the touch-sensing cover 11, but it is not limited thereto.

Accordingly, the touch-sensing cover 11 and the panel 12 are respectively disposed on the two opposite sides of the hand-held electronic device 1. It avoids that the user's hand may shade the screen displayed by the panel 12 when he operates the hand-held electronic device 1, so as to avoid inadvertent touch.

Referring to FIG. 2 for example, the hand-held electronic device 1 in the embodiment further includes a memory unit 15. It can be for example but not limited to ROM (Read-only Memory), RAM (Random Access Memory), flash memory, FPGA (Field-Programmable Gate Array), or other kinds of memories, and it is not limited thereto. In the embodiment, the memory unit 15 is RAM for example, and it is coupled to the control unit 13 by the signal bus similarly.

In the embodiment, the memory unit 15 stores the operation system, application programs, data processing programs and electronic data of various document, etc. The operation system is the program managing the hardware and software resources of computer. The application program can be a text editor or an email program, etc. In the embodiment, data processing programs are the programs which detects the data structure of electronic data and generates corresponding link instructions. In the embodiment, the control unit 13 is a central processing unit (CPU) for example, and the control unit 13 executes these programs.

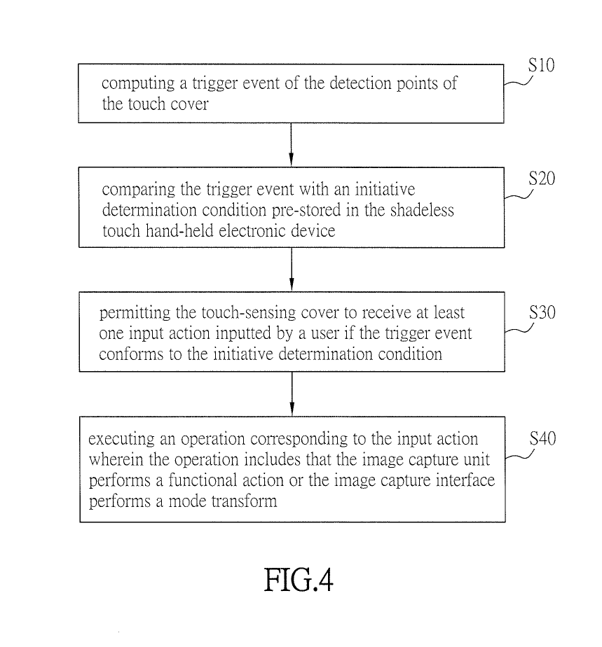

FIG. 4 is a flow chart showing the steps of the computer-executed according to the embodiment of the invention. Referring to FIG. 4, the computer-executed method in the embodiment executes following steps on the hand-held electronic device 1: computing a trigger event of a plurality of detection points of the touch-sensing cover (step S10); comparing the trigger event with an initiative determination condition pre-stored in the shadeless touch hand-held electronic device (step S20); permitting the touch-sensing cover to receive at least one input action inputted by a user if the trigger event conforms to the initiative determination condition (step S30); and executing an operation corresponding to the input action. The operation includes that the image capture unit performs a functional action or the image capture interface performs a mode transform (step S40).

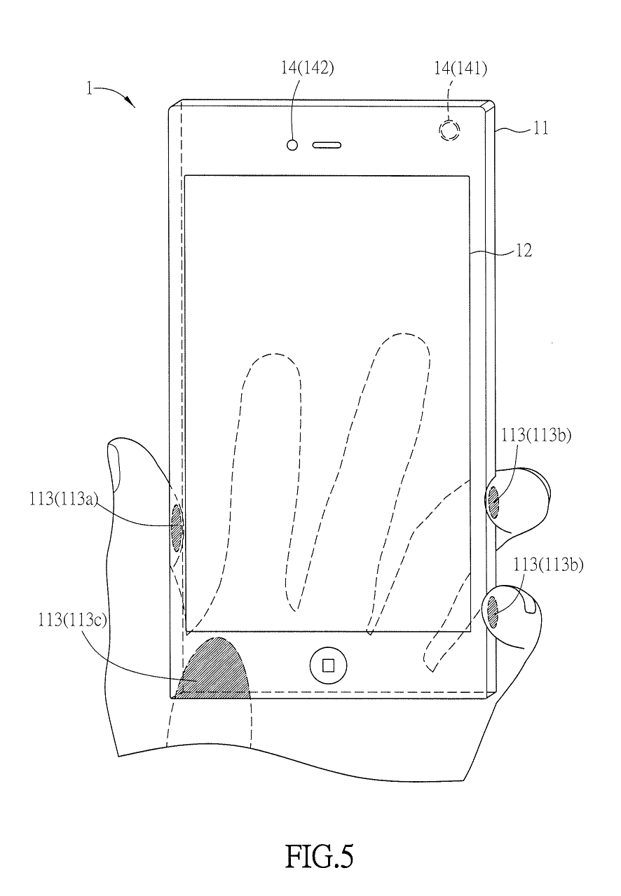

Referring to FIG. 2 and FIG. 5, FIG. 5 is a schematic diagram showing that the detection points of the touch-sensing cover in FIG. 1 are triggered. In detail, when the user operates the hand-held electronic device 1, the user's holding habit can be predefined on the operation setting interface. The control unit 13 can analyze a trigger event of the detection points which is triggered by the user on the operation setting interface, and define it as the initiative determination condition and save it in the memory unit 15. The trigger event includes a trigger quantity, a trigger quantity distribution, a trigger morphology (which can refer to trigger appearance), a trigger time, a trigger location (which can refer to trigger position) or a trigger frequency, etc. Taking the trigger quantity distribution, the trigger morphology and the trigger location as the trigger event for example, when the user holds the hand-held electronic device 1, the control unit 13 can analyze the position of the triggered detection point due to the user's holding and define the region where the number of the adjacent triggered detection point is larger than a predetermined value as a trigger zone 113. Taking FIG. 5 for example, in this embodiment, one sidewall of the touch-sensing cover 11 has a trigger zone 113a, the other sidewall has two trigger zones 113b, and the surface of the touch-sensing cover 11 opposite the panel 12 has a trigger zone 113c. In detail in this embodiment, the trigger quantity distribution and the trigger location respectively indicate the quantity and location of each trigger zone, and the trigger morphology indicates the shape or appearance of each trigger zone 113, i.e. the shapes or appearances of the trigger zones 113a, 113b and 113c. Moreover, the trigger frequency may indicate the click frequency at some certain locations, and the trigger time may indicate that the holding time exceeds a certain time period or it is related to the user's living habit.

After the user sets up the initiative determination condition on the operation setting interface and saves it in the memory unit 15, the control unit 13 can compare other trigger events with the initiative determination condition. Once other trigger events occur, the control unit 13 will compute the trigger quantity, the trigger quantity distribution, the trigger morphology, the trigger time, the trigger location or the trigger frequency of the detection points on the touch-sensing cover 11 triggered by other trigger events, and then compares the computed result with the initiative determination condition pre-stored in hand-held electronic device 1. Besides, in some embodiments, in order to enhance the security of the hand-held electronic device 1, the control unit 13 computes the trigger event on the touch-sensing cover 11 at intervals of a predefined time period, namely the trigger quantity, the trigger quantity distribution, the trigger morphology, the trigger time, the trigger location or the trigger frequency of triggered detection points at different times.

The touch-sensing structure 112 is permitted to receive at least one input action inputted by the user if the trigger event conforms to the initiative determination condition. In other words, the trigger quantity, the trigger quantity distribution, the trigger morphology, the trigger time, the trigger location or the trigger frequency must satisfy the initiative determination condition first, then the control unit 13 executes or starts to execute other action and it permits the touch-sensing structure 112 to receive the touch input from the user. The hand-held electronic device 1 executes the operation corresponding to the input action. It is noted that in the embodiment, the input action is implemented with the user's single hand. In the embodiment, the operation refers to that the image capture unit performs the functional action or the image capture interface performs the mode transform, and they will be explained later. Therefore, when another user holds the hand-held electronic device 1 and want to operate it, he fails to operate the hand-held electronic device 1 because the trigger event such as the trigger quantity, the trigger quantity distribution, the trigger morphology, the trigger time, the trigger location or the trigger frequency, etc. does not conform to the initiative determination condition which the original user has predefined. Therefore, the security of the hand-held electronic device 1 is enhanced.

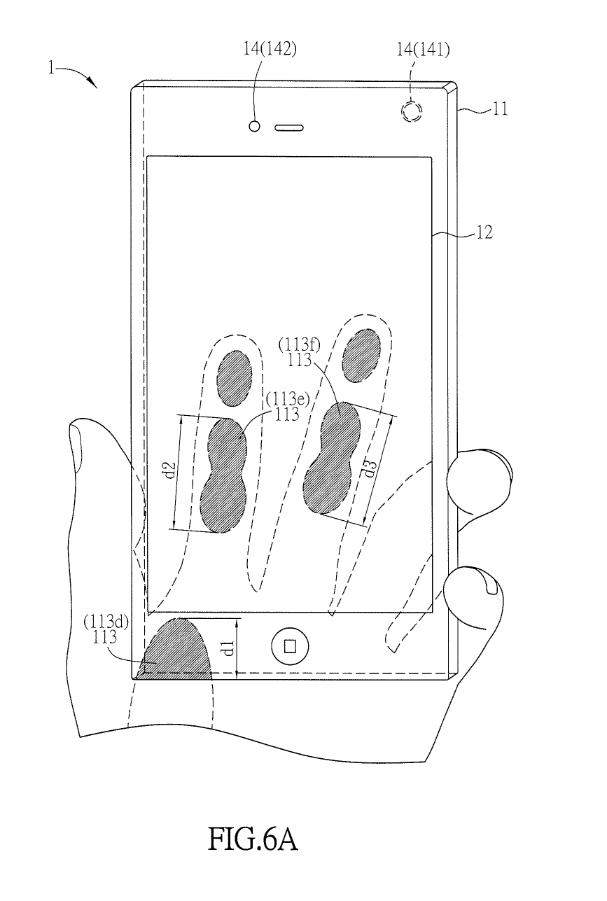

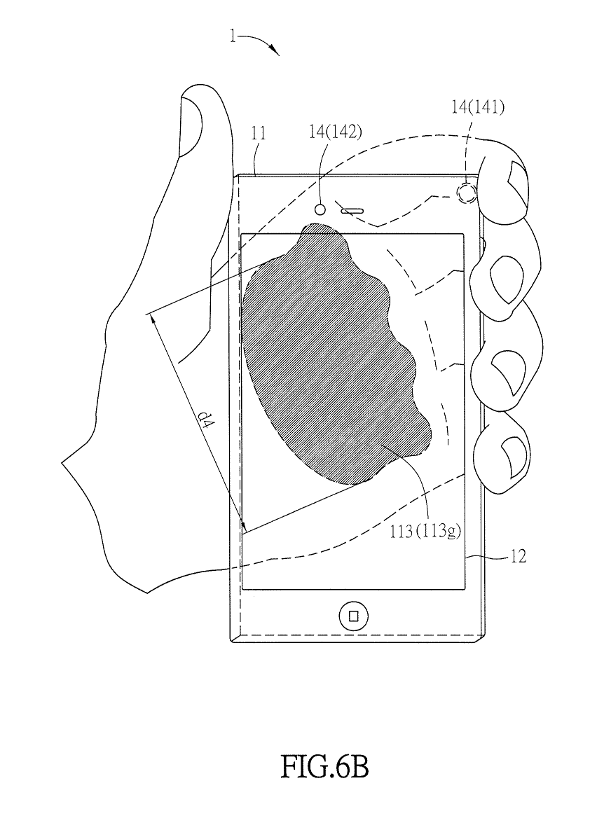

FIG. 6A to FIG. 6B are another schematic diagrams showing that the detection points of the touch-sensing cover in FIG. 1 are triggered. Referring to FIG. 6A, here, if the trigger morphology indicates multiple area contacts, it is determined not to conform to the initiative determination condition. Here, multiple means two or more than two. In the embodiment, “area contact” means that the diameter of a single touch region on the touch-sensing cover 11 which the user contacts or the longest distance from one touch edge to the other touch edge is longer than 7 mm. Taking FIG. 6 for example, because the trigger zones 133d, 133e, 113f are not circles, therefore when longest distances d1, d2, d3 from one touch edge to the other touch edge of the trigger zones 133d, 133e, 113f or more trigger zones are longer than 7mm, it is directly determined that the trigger event does not conform to the initiative determination condition. The above configuration is based on the condition that it is easy to generate the trigger morphology indicating multiple area contacts when the user does not perform touch operation on the hand-held electronic device 1 and he only simply holds the hand-held electronic device 1, and thus such the trigger event is determined not to conform to the initiative determination condition. Then referring to FIG. 6B, if the trigger morphology of the trigger event indicates single area contact and the position of the single area contact is located at the upper half of the hand-held electronic device 1, it is determined not to conform to the initiative determination condition. The above configuration is based on the condition that when the user regularly holds the hand-held electronic device 1 and utilizes his finger to perform touch operation on the touch-sensing cover 11, the palm of the user may form a trigger zone of area contact on the lower half of the hand-held electronic device 1, and the trigger zone of area contact is not formed on the upper half. As to the touch region formed on the upper half by the touch-sensing cover 11 and the finger performing the touch operation, its diameter or the longest distance from one touch edge to the other touch edge is usually not longer than 7 mm. When there is a trigger zone 113g like FIG. 6B on the upper half of the hand-held electronic device 1 and the longest distance from its one touch edge to the other touch edge is longer than 7 mm, it is very possible that the user does not perform touch operation but for example wipes the cover 111 or merely holds the hand-held electronic device 1. Therefore, if the trigger morphology of the trigger event indicates single area contact and it is located at the upper half of the hand-held electronic device 1, it is similarly directly determined not to conform to the initiative determination condition. Here, to distinguish between the upper half and the lower half can depend on the center of the cover 111 or the center of the touch-sensing structure 112, and it still depends on actual situation when the user operates the hand-held electronic device 1. The portion upper than the center is regarded as the upper half, and the portion lower than the center is regarded as the lower half.

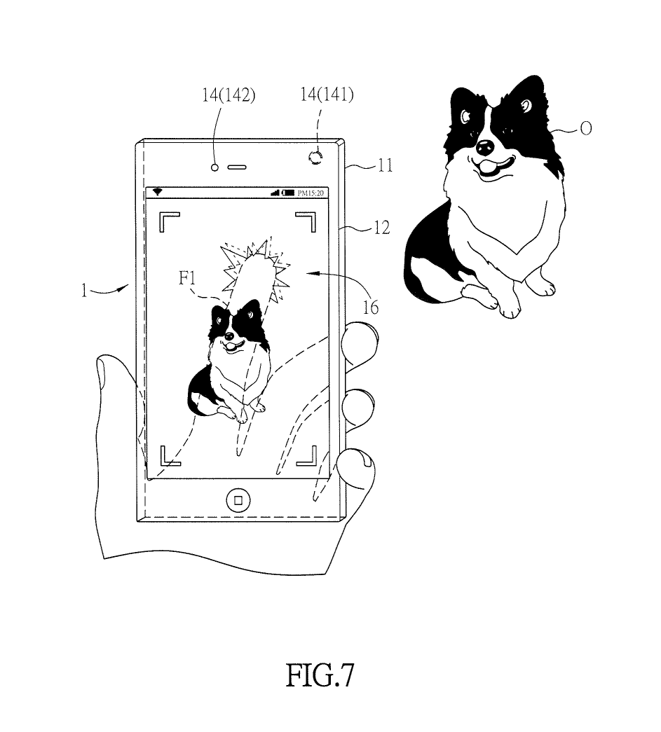

The following description will explain that the image capture unit performs a functional action or the image capture interface performs a mode transform. FIG. 7 is a schematic diagram showing that the panel 12 in FIG. 1 displays the image capture interface 16. Referring to FIG. 7, in the embodiment, the panel 12 of the hand-held electronic device 1 displays an image capture interface 16. In addition to see the content displayed by the image capture interface 16, the user can contacts the touch-sensing cover 11 to get the image capture units 141, 142 of the hand-held electronic device 1 to accordingly perform a functional action so as to accordingly perform a display on the image capture interface 16. The following takes the image capture unit 141 (the back camera) for example. In other embodiments, the image capture unit 142 (the front camera) can have similar operation contents and thus they are not repeated here. In detail, when the user aims the image capture unit 141 at the subject O (for example but not limited to a dog in FIG. 7) and utilizes the finger F1 to click the touch-sensing cover 11 as the input action, the image capture unit 141 performs an action to photograph and the image capture unit 141 will photograph the subject O to be a digital photo. Here, clicking may include clicking once or clicking twice continuously. Clicking twice continuously can be also called double-click or double-tap.

In other embodiments, if the user aims the image capture unit 141 at the subject O and utilizes the finger F1 to continuously contact the touch-sensing cover 11 over a default period of time, the image capture unit 141 will execute or start to execute the action to record a video so as to form a digital video. If the finger F1 of the user contacts the touch-sensing cover 11 over the default time period, the recording will continue. If the finger F1 exits from (not contacts) the touch-sensing cover 11, the recording will break. For example, assuming that the default time period is 3 seconds, when the finger F1 continuously contacts the touch-sensing cover 11 over 10 seconds and then exits, the image capture unit 141 starts to record a video for the subject O at the fourth second from the finger F1 contacting the touch-sensing cover 11 and stop recording at the 10th second. The above is for example but not limited thereto.

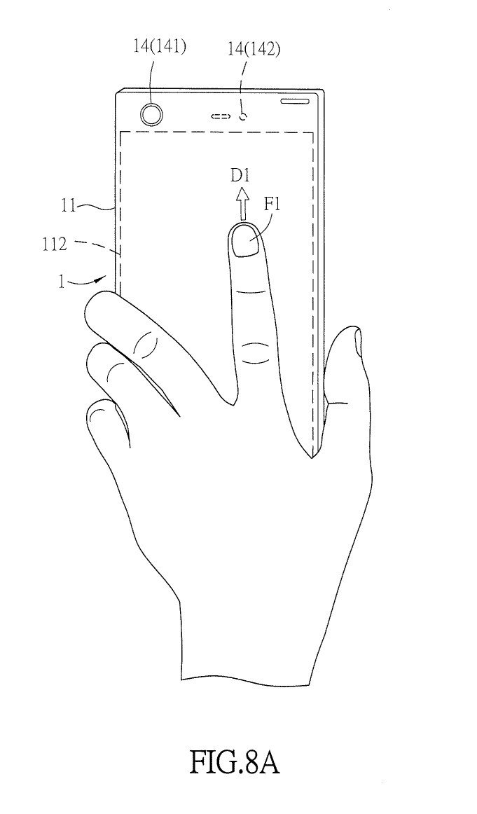

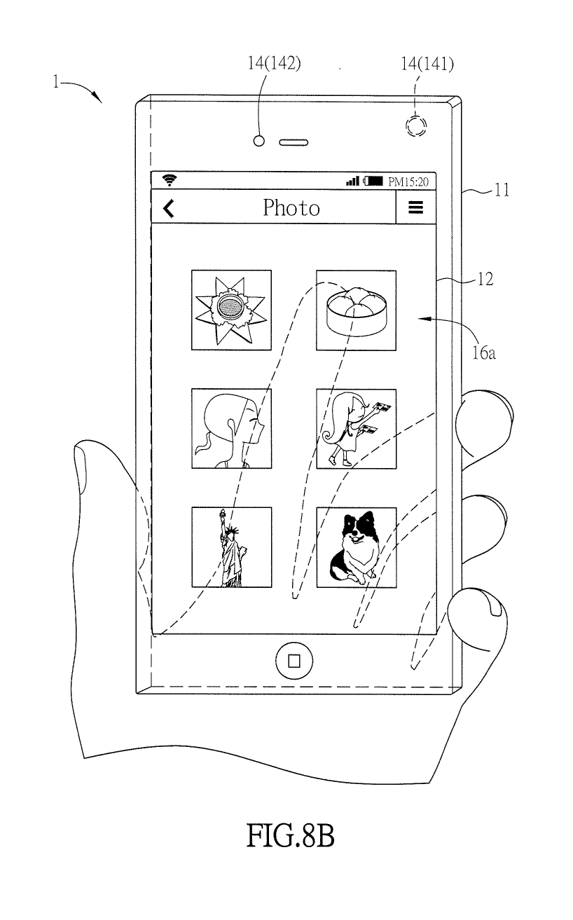

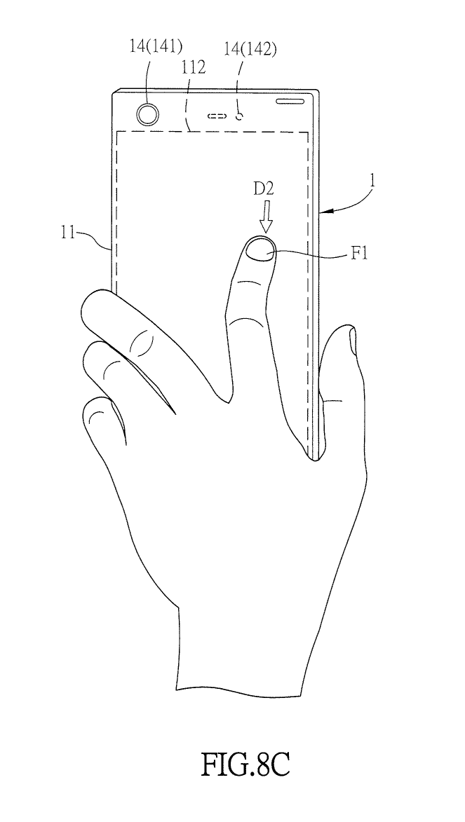

FIG. 8A is a schematic diagram showing that the user operates the shadeless touch hand-held electronic device in FIG. 1 along the first direction. FIG. 8B is a schematic diagram showing that the panel 12 in FIG. 1 displays the photo browsing mode. Referring to FIG. 7, FIG. 8A and FIG. 8B, first, assuming that the hand-held electronic device 1 operates in the capture mode like FIG. 7, when the user utilizes the finger F1 to slide along the first direction D1 on the touch-sensing cover 11 as the input action like FIG. 8A, the image capture interface 16 of the panel 12 will enter the photo browsing mode from the capture mode like the image capture interface 16a in FIG. 8B. Therefore, the user can through the image capture interface 16a brows the photos formerly stored in the memory unit 15 (as shown in FIG. 2) of the hand-held electronic device 1. It is noted that the first direction D1 here is upward for example, but in some embodiments, the first direction D1 is not limited to upward.

FIG. 8C is a schematic diagram showing that the user operates the shadeless touch hand-held electronic device in FIG. 1 along the second direction. Here in contrast, assuming that the hand-held electronic device 1 operates in the photo browsing mode like FIG. 8B, when the user utilizes the finger F1 to slide along the second direction D2 on the touch-sensing cover 11 as the input action like FIG. 8C, the image capture interface 16a of the panel 12 will return to the capture mode from the photo browsing mode like the image capture interface 16 in FIG. 7.

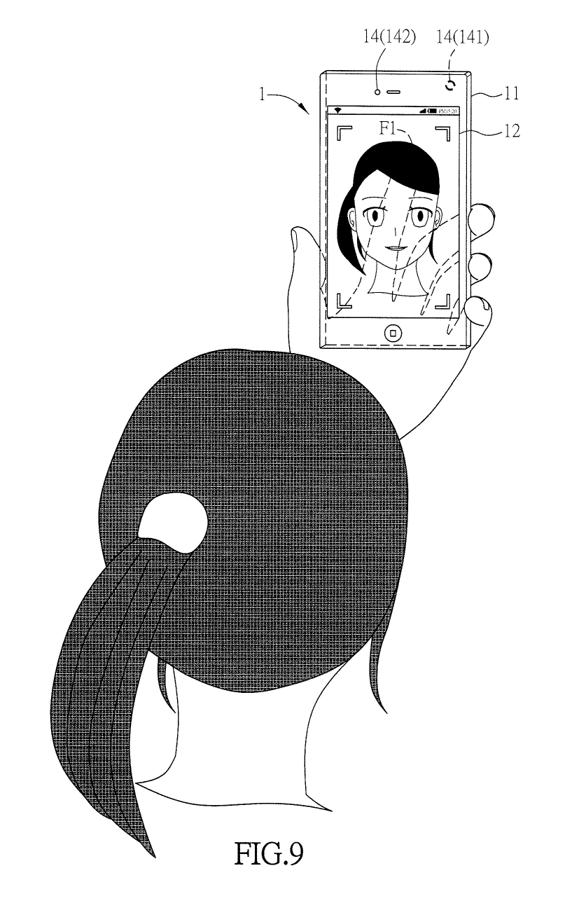

FIG. 9 is a schematic diagram showing the shadeless touch hand-held electronic device 1 in FIG. 1 in self-timer mode. Referring to FIGS. 7, 8A, 8C and 9, the difference from the previous is that assuming the image capture unit 141 in the hand-held electronic device 1 formerly executes the photograph or record function like FIG. 7, when the user utilizes the finger F1 to slide along the first direction D1 on the touch-sensing cover 11 like FIG. 8A, the image capture unit 142 will replace the image capture unit 141. Namely, in the hand-held electronic device 1, the image capture unit 142 executes the photograph or record function like FIG. 9 instead. Therefore, it is convenient for the user to take a photograph himself. When the user later utilizes the finger F1 to slide along the second direction D2 on the touch-sensing cover 11 like FIG. 5C, the image capture unit 141 replaces the image capture unit 142 to execute the photograph or record function.

Additionally, in other embodiments, the user may slide on the touch-sensing cover 11 along the first direction D1 or the second direction D2 to adjust the photo or video captured by the image capture unit 141, 142. For example, various capture modes or filters can be pre-stored in the hand-held electronic device 1. The capture modes include for example outdoor mode, rain mode, party mode or other modes. The filters include for example weakening, brightening, smoothing or other filters. The user can utilize the finger F1 to select capture mode or filter by sliding along a designate direction.

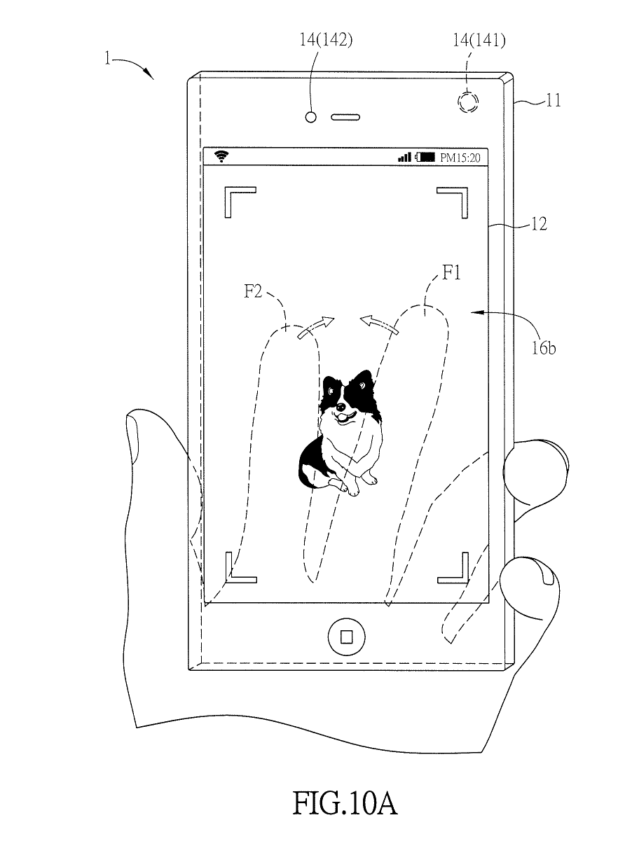

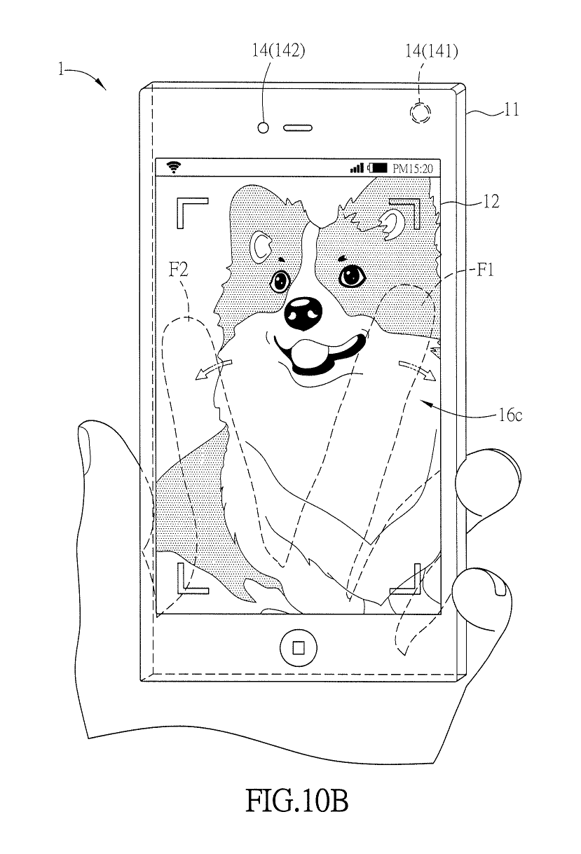

FIG. 10A is a schematic diagram showing that the user operates the shadeless touch hand-held electronic device in FIG. 1 by pinch. FIG. 10B is a schematic diagram showing that the user operates the shadeless touch hand-held electronic device in FIG. 1 by stretch. Referring to FIG. 7, FIG. 10A and FIG. 10B, here similarly, it takes the image capture unit 141 photographing the subject O for example. When the user utilizes the fingers F1, F2 to slide toward each other on the touch-sensing cover 11 (pinch, or sliding inward) like FIG. 10A, the image capture unit 141 performs the action to zoom out. In detail, the object image displayed by the image capture interface 16b becomes smaller, and whole the capture range becomes larger. When the user utilizes the fingers F1, F2 to slide away from each other on the touch-sensing cover 11 (stretch, or sliding outward) like FIG. 10B, the image capture unit 141 performs the action to zoom in. In detail, the object image displayed by the image capture interface 16c becomes larger, and whole the capture range becomes smaller.

In addition, a touch-sensing cover for a shadeless touch hand-held electronic device is also provided. The shadeless touch hand-held electronic device includes the touch-sensing cover, a panel, an image capture unit and a control unit. The panel displays an image capture interface. The touch-sensing cover comprises a cover and a touch-sensing structure. The cover is disposed on the side of the shadeless touch hand-held electronic device opposite the panel. Partial or whole area of touch-sensing structure is disposed on the cover. The touch-sensing structure is coupled to the control unit. The touch-sensing structure has a plurality of detection points which can be triggered. The control unit computes the trigger event of the detection points, and compares the trigger event with the initiative determination condition pre-stored in the shadeless touch hand-held electronic device. The touch-sensing structure is permitted to receive at least one input action inputted by the user if it is conformed to the initiative determination condition, and the operation is correspondingly performed according to the input action. The operation comprises that the image capture unit executes the action to photograph, the image capture unit executes the action to record a video, or the image capture interface enters the photo browsing mode, etc. Because other elements of the touch-sensing cover and their relationships can refer to the previous descriptions, they are not repeated here.

Besides, in some embodiments, the hand-held electronic device 1 further includes a NFC (near field communication) unit which has a NFC chip and an antenna. The NFC chip is electrically connected to the control unit 13, and the antenna is disposed on the cover 111 or the touch-sensing structure 112, and they are not limited thereto. When the user want to utilize the hand-held electronic device 1 to perform near field communication with another electronic device, he can take the hand-held electronic device 1 close to another electronic device capable of near field communication, so the antenna and the NFC chip are utilized to transmit or receive the electronic data to or from another electronic device.

As mentioned above, as to the shadeless touch hand-held electronic device, the touch-sensing cover and the computer-executed method, because the user can perform touch operation on the touch-sensing cover of the shadeless touch hand-held electronic device, his fingers will not shade the view or the software item displayed by the panel. Thus, it also avoids inadvertently touch problems of opening the link due to high information content density on the display. In addition, because the user utilizes the touch-sensing cover to operate the electronic device, the scratch on the panel can be reduced. Besides, because the user utilizes the touch-sensing cover to perform touch operation, he can hold it by one hand and uses his finger such as forefinger or middle finger of the same hand to operate the electronic device. In comparison with that conventionally one hand holds it and only the thumbs can perform operation, the efficiency and convenience of hand control operation is enhanced and better user experience is achieved.

Furthermore, when the user uses the shadeless touch hand-held electronic device under the sun or the light source, he can hold the shadeless touch hand-held electronic device just by one hand and use the touch-sensing cover to block the sunlight or light source. Due to the panel information benefiting from the touch-sensing cover which blocks the sunlight, the sunlight visibility of the panel is improved, and it can be implemented without advanced OLED or electric paper display panel technique.

In addition, because the shadeless touch hand-held electronic device must firstly satisfy the precondition that the trigger event such as the trigger quantity, the trigger quantity distribution, the trigger morphology, the trigger time, the trigger location or the trigger frequency, etc. conforms to the initiative determination condition, then the touch-sensing cover is permitted to receive at least one input action inputted by the user and an operation is correspondingly performed according to the input action. The operation includes that the image capture unit performs a functional action or the image capture interface performs a mode transform. Therefore, when other user operates the shadeless touch hand-held electronic device, because the trigger event such as the trigger quantity, the trigger quantity distribution, the trigger morphology, the trigger time, the trigger location or the trigger frequency, etc. is distinct from the initiative determination condition which is predefined by the origin user, the shadeless touch hand-held electronic device is forbidden to operate so as to enhance the security of protecting the user information in the shadeless touch hand-held electronic device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shadeless touch hand-held electronic device, comprising:
a touch-sensing cover, having a cover and a touch-sensing structure, wherein partial or whole area of the touch-sensing structure is disposed on the cover and has a plurality of detection points;
a panel, displaying an image capture interface;
at least one image capture unit; and
a control unit, electrically connected to the touch-sensing cover, the panel and the image capture unit, and executing following steps of:
computing a trigger event of the detection points;
comparing the trigger event with an initiative determination condition pre-stored in the shadeless touch hand-held electronic device;
permitting the touch-sensing structure to receive at least one input action inputted by a user if the trigger event conforms to the initiative determination condition; and
executing an operation corresponding to the input action;
wherein the operation comprises that the image capture unit performs a functional action or the image capture interface performs a mode transform.

2. The shadeless touch hand-held electronic device of claim 1, wherein the image capture unit is disposed on the same side or the opposite side of the panel of the shadeless touch hand-held electronic device.

3. The shadeless touch hand-held electronic device of claim 1, wherein the touch-sensing structure is single-layer or double-layer.

4. The shadeless touch hand-held electronic device of claim 1, wherein a wiring connecting to the touch-sensing structure is gathered to a single side for wiring outlet.

5. The shadeless touch hand-held electronic device of claim 1, wherein, a width of the touch-sensing structure is less than that of the cover by 5%˜10%.

6. The shadeless touch hand-held electronic device of claim 1, wherein the area of the touch-sensing structure has a ratio relationship to the area of the panel, and the control unit converts an input position of the touch-sensing structure to a display position of the panel according to the ratio relationship.

7. The shadeless touch hand-held electronic device of claim 1, wherein the touch-sensing structure is capable of a wireless power transmission.

8. The shadeless touch hand-held electronic device of claim 1, wherein the touch-sensing cover further comprises a near field communication unit, the near field communication unit has a near field communication chip and an antenna, and the near field communication chip is electrically connected to the control unit, and the antenna is disposed on the cover or the touch-sensing structure.

9. The shadeless touch hand-held electronic device of claim 1, wherein the user operates by one hand and the touch-sensing cover faces a light source or the back of the panel faces the light source.

10. The shadeless touch hand-held electronic device of claim 1, wherein the material of the touch-sensing structure comprises metal mesh, metal nanowires, transparent conducting film, carbon nanotube or graphene.

11. A computer-executed method, applied to a shadeless touch hand-held electronic device, wherein the shadeless touch hand-held electronic device comprises a touch-sensing cover, a panel, an image capture unit and a control unit, the panel displays an image capture interface, the computer-executed method executed, on the shadeless touch hand-held electronic device comprising following steps of:
computing a trigger event of a plurality of detection points of the touch-sensing cover;
comparing the trigger event with an initiative determination condition pre-stored in the shadeless touch hand-held electronic device;
permitting the touch-sensing cover to receive at least one input action inputted by a user if the trigger event conforms to the initiative determination condition; and
executing an operation corresponding to the input action;
wherein the operation comprises that the image capture unit performs a functional action or the image capture interface performs a mode transform.

12. The method of claim 11, wherein the image capture unit is disposed on the same side or the opposite side of the panel of the shadeless touch hand-held electronic device.

13. The method of claim 11, wherein if the input action is that a single finger contacts or touches the touch-sensing cover, the operation is that the image capture unit performs the functional action to photograph.

14. The method of claim 11, wherein if the input action is that the single finger contacts the touch-sensing cover over a default period of time, the operation is that the image capture unit performs the functional action to record a video.

15. The method of claim 11, wherein if the input action is that a single finger slides along a first direction on the touch-sensing cover, the operation is that the image capture interface performs the mode transform of entering a photo browsing mode from a capture mode.

16. The method of claim 11, wherein if the input action is that a single finger slides along a second direction on the touch-sensing cover, the operation is that the image capture interface performs the mode transform of entering a capture mode from a photo browsing mode.

17. The method of claim 11, wherein if the input action is that two fingers slide toward each other on the touch-sensing cover, the operation is that the image capture unit performs the functional action to zoom out.

18. The method of claim 11, wherein if the input action is that two fingers slide away from each other on the touch-sensing cover, the operation is that the image capture unit performs the functional action to zoom in.

19. The method of claim 11, wherein the trigger event comprises a trigger quantity, a trigger quantity distribution, a trigger morphology, a trigger time, a trigger location or a trigger frequency.

20. A touch-sensing cover for a shadeless touch hand-held electronic device, wherein the shadeless touch hand-held electronic device comprises the touch-sensing cover, a panel, an image capture unit and a control unit, the panel displays an image capture interface, the touch-sensing cover comprising:
a cover,disposed on the side of the shadeless touch hand-held electronic device opposite the panel; and
a touch-sensing structure, wherein partial or whole area is disposed on the cover, and the touch-sensing structure has a plurality of detection points;
wherein the control unit computes a trigger event of the detection points and compares the trigger event with an initiative determination condition pre-stored in the shadeless touch hand-held electronic device, permits the touch-sensing structure to receive at least one input action inputted by a user if the trigger event conforms to the initiative determination condition, and executes an operation corresponding to the input action, wherein the operation comprises that the image capture unit performs a functional action or the image capture interface performs a mode transform.
